(19) United States
(12) Patent Application Publication
(10) Pub. No.: US 2007/0198331 A1
(43) Pub. Date: Aug. 23, 2007

(54) System and method for monitoring trading manager performance

(75) Inventors: Gerald T. Hurley, Chicago, IL (US); Anil Govind Mudholkar, Chicago, IL (US); Tawee Pimsarn, Oak Park, IL (US); Maneesak Pimsarn, Forest Park, IL (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/700,261

(22) Filed: Jan. 31, 2007

Related U.S. Application Data
(60) Provisional application No. 60/764,066, filed on Jan. 31, 2006.

(51) Int. Cl. H04M 3/51; G06F 11/34

(52) U.S. Cl. 705/11

(57) ABSTRACT

A system for monitoring trade manager performance includes a user interface module, a data warehouse in communication with said user interface module, an analytics module in communication with said data warehouse, and a data conversion module in communication with said data warehouse and with at least one file server, and operable to convert data received via said at least one file server from a plurality of sources, said data being in two or more different formats, and to convert said data into a common data format, wherein said data warehouse is operable to store data received from said data conversion in a common data format, and wherein said user interface module is operable to receive from a user a request for information regarding a fund manager and to display said requested information.

This application claims the benefit of the U.S. Provisional Patent Application No. 60/764,066 filed on Jan. 31, 2006, which is hereby incorporated by reference.

### BACKGROUND OF THE INVENTION

1. Field of the Invention

The present invention relates to a system and method for monitoring trading manager performance. More particularly, the present invention relates to a system and method for collecting, normalizing, and analyzing trading activity data from disparate data sources for monitoring trading manager performance.

2. Discussion of the Related Art

Analysis of trading activity of financial instruments, such as stocks, bonds, and futures, for example, involves a complex array of information. In general, each fund backed by these financial instruments is managed by a fund manager, either an individual or a firm, who determines which specific instrument to buy, sell, or trade. Therefore, in order to determine if a particular fund is a good investment, it is important to review the performance of the fund manager.

The information that is needed to accurately determine the performance of fund manager, such as a commodity trading advisor (“CTA”), for example, requires up-to-date information from a variety of data sources. However, the data sources, such as trading exchanges (e.g., NASDAQ) and quote providers (e.g., Bloomberg), do not use the same conventions for accumulating and maintaining their data. For example, the exchange code used by one data source may not be same as the exchange code used by another data source.

Accordingly, in order to obtain a reasonably accurate performance analysis of a fund manager, analysis of data from these data sources must be performed separately. Furthermore, even if an analysis is performed on data obtained from each of these data sources, consolidation and accurate comparison becomes cumbersome, if not impossible, because of the disparate characterization of the underlying data. Moreover, due to the amount of correlation and calculations that must be made, only monthly performance analysis of fund managers is currently available.

### SUMMARY OF THE INVENTION

Accordingly, the present invention is directed to a system and method for monitoring trading manager performance that substantially obviates one or more problems due to limitations and disadvantages of the related art.

An object of the present invention is to provide a system and method for monitoring trading manager performance that converts data from disparate data source into a common data format.

Another object of the present invention is to provide a system and method for monitoring trade manager performance that performs intraday and end-of-day analysis.

Yet another object of the present invention is to provide a system and method for monitoring trade manager performance through a web-style portal.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system for monitoring trade manager performance includes a user interface module, a data warehouse in communication with said user interface module, an analytics module in communication with said data warehouse, and a data conversion module in communication with said data warehouse and with at least one file server, and operable to convert data received via said at least one file server from a plurality of sources, said data being in two or more different formats, and to convert said data into a common data format, wherein said data warehouse is operable to store data received from said data conversion in a common data format, and wherein said user interface module is operable to receive from a user a request for information regarding a fund manager and to display said requested information.

In another aspect, a method includes receiving data in two or more different formats, converting said data into a common data format, storing said converted data in said common data format, receiving a request for information regarding a fund manager, retrieving said requested information from said converted data stored in said common data format, and displaying said requested information.

In yet another aspect, software includes software operable to receive data in two or more different formats, software operable to convert said data into a common data format, software operable to store said converted data in said common data format, software operable to receive a request for information regarding a fund manager, software operable to retrieve said requested information from said converted data stored in said common data format, and software operable to display said requested information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows a schematic system diagram of an exemplary embodiment of the present invention;

FIG. 2 shows a block diagram of an exemplary CTADB database structure in accordance with the present invention;

FIG. 3 shows a block diagram of an exemplary CTAResearch database structure in accordance with the present invention;

FIG. 4-7 show various exemplary screenshots displaying P&L analysis in accordance with the present invention; and

FIGS. 8-13 show various exemplary screenshots displaying manager information in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

In general, the present invention is directed to an analytic tool used determine historical performance of a trading account or a group of trading accounts. The analytic tool may be accessed over a network, such as a local area network (LAN), wide area network (WAN), the Intranet, and the Internet. The analytic tool may be non-application specific, thereby allowing access through a web browser arranged in a portal-like interface.

Summary information on the historical performance of the trading account may be aggregated by sector, market, account, fund, or manager, for example, and detailed data may be presented by invoking one or more views with drill-down capability. For instance, the analytic tool according to the present invention provides manager and managed account analyses such as interday profit and losses (“P&L”), historical performance, positions, and risk analytics. More particularly, the system and method of the present invention provides intraday and end-of-day monitoring and analysis of funds and trading managers' strategy and performance including, but not limited to:

| | |
|---|---|
| trade reconciliation | consolidated/detailed trade activity |
| position reconciliation | equity (i.e., account balances) |
| futures position totals | forward positions |
| margin report per currency | currency exchange rates (“FX”) |
| cash activity | margin report per account |
| collateral | margin requirements |
| commission and fees | options positions totals |
| consolidated closed | settlement prices and contract dates |
| forwards/futures/options | EOD trades to reconcile |

In this regard, trade data are collected from a variety of diverse trade data sources. Data for each trade is then stored in a common data format (“CDF”) within a database that is accessible by the analytic tool. The collected data in CDF enables the analytic tool to perform various historical performance and risk analyses based on quantitative and qualitative data, support various reporting capabilities, and provide single manager metrics, benchmark statistics, peer group analysis, portfolio analytics, and the like. Moreover, the database also stores documents related to the trading accounts and their managers (e.g., certified trading advisors, or “CTA”s). Accordingly, the present invention provides a single point of access to all documents for each CTAs, such as new letters, performance reports, trading advisory agreements, and the like, as well as the analytics for the funds managed by the CTAs.

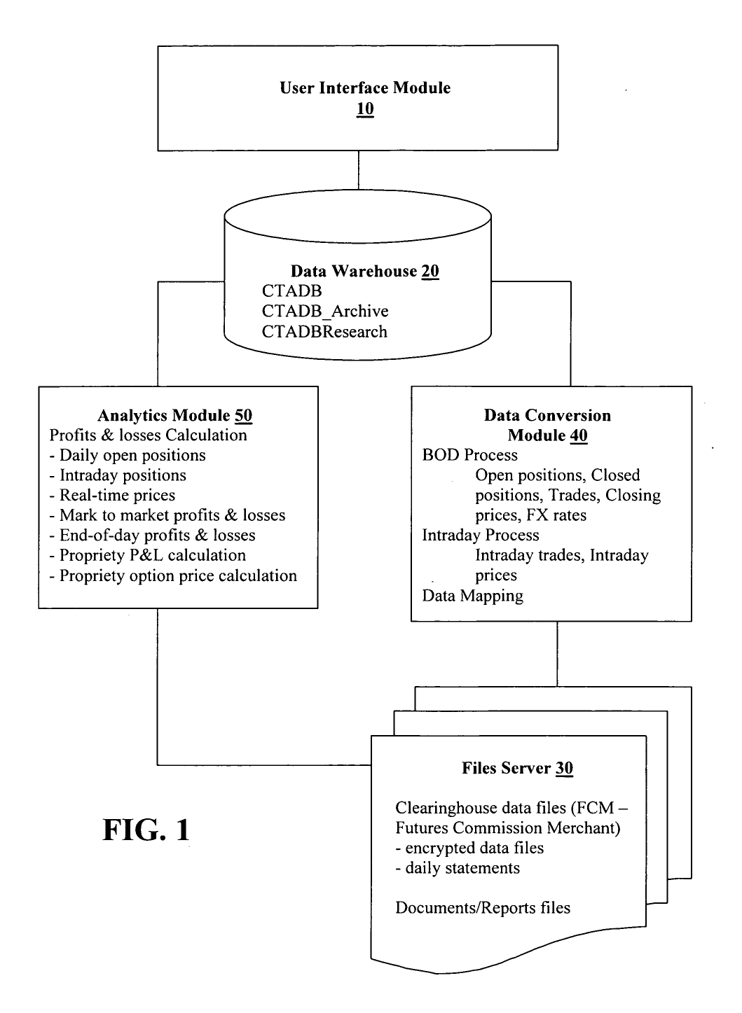

Specifically, FIG. 1 shows a schematic view of a system architecture in accordance with an exemplary embodiment of the present invention. As shown in FIG. 1, the present invention includes a user interface module 10, data warehouse 20, file servers 30, data conversion module 40, and analytics module 50. The user interface module 10 includes a plurality of applications that provide access to the analytics and documents stored in the data warehouse 20. In an exemplary embodiment, the user interface module 10 includes a web portal-like interface.

The data warehouse 20 includes an SQL (structured query language) server with one or more databases. The exemplary embodiment shown in FIG. 1 includes three databases (CTADB, CTADB_Archive, and CTAResearch). However, any number of databases may be used without departing from the scope of the present invention. The databases CTADB, CTADB_Archive, and CTAResearch store daily and historic CDF data related to trade information received from various disparate data sources.

In this regard, file server (or servers) 30 provide trade information, such as clearing house data files related to futures commission merchants (“FCM”), for example, to the data conversion module 40. The file server 30 receives data from various data sources (not shown) throughout the day. The file server 30 provides the data files to the data conversion module 40, generally in encrypted form.

The data conversion module 40 performs data mapping to convert the received data into a common data format (CDF) and stores the data in the data warehouse 20. The data conversion module 40 also performs beginning-of-day (“BOD”) and intraday data processing on the data received from the file server 30. The conversion processing will be described in further detail below.

The analytics module 50 performs various calculations on the converted data stored in the data warehouse 20 to provide various performance statistics. For example, analytics module 50 may perform various profits and losses (P&L) calculations based on daily open positions, intraday positions, real-time prices. Some of the calculations include mark to market P&L, end-of-day (EOD) P&L, and proprietary P&L calculations, and proprietary option price calculations. The analytics information may be calculated and stored periodically in the data warehouse 20 or calculated on the fly in response to a request from the user interface module 10. The analytics may also be generated as reporting documents and sent to the various file servers providing the data to the system of the present invention.

As briefly described above, the data conversion module 40 converts the trade data into a common data format. As shown in FIG. 1, the data conversion module 40 receives data files from the file server (or servers) 30 and transforms the data into a common data format to be stored in the data warehouse 20. The data conversion module 40 may be implemented as a separate functional module, such as a stand-alone application, or as a part of the SQL server function of the data warehouse 20.

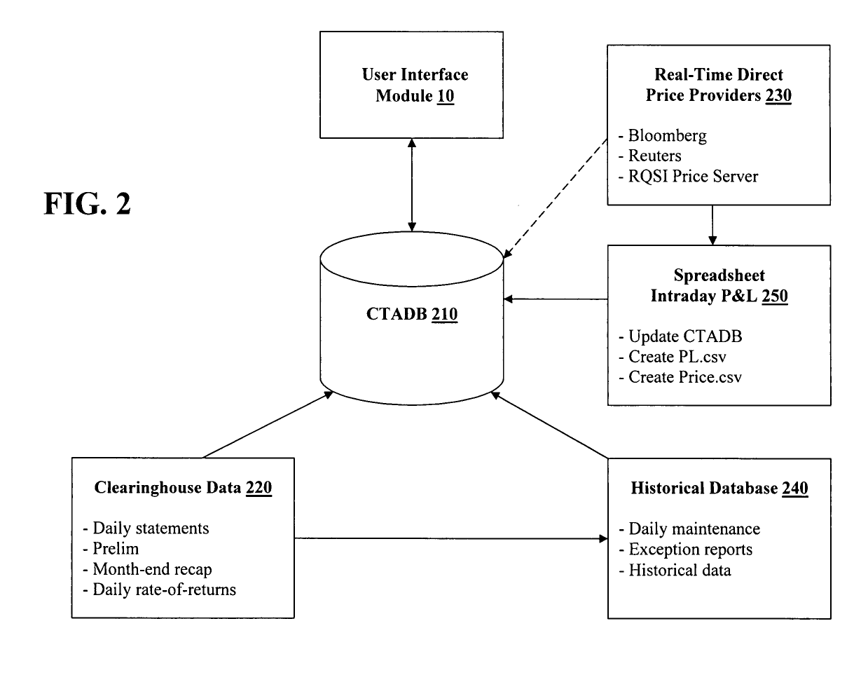

For example, FIG. 2 shows a block diagram of the data conversion process according to an exemplary embodiment of the present invention where the data conversion module 40 (of FIG. 1) is implemented as a conversion table of the CTADB database 210. As shown, the CTADB database 210 receives disparate data from various data sources, such as clearing house data 220, real-time price data 230 from direct price providers, such as Bloomberg, Reuters, and RQSI price servers, for example. Other price/quote providers may be used without departing from the scope of the present invention. Already processed data may also be received from other databases 240 and applications 250, such as a spreadsheet.

Specifically, the data conversion module 40 receives encrypted trade data from external data sources, such as clearing house data. The encrypted data files may be from various future commission merchants (“FCM”s) and encrypted with pretty good privacy (“PGP”) encryption, for example. The data conversion module 40 decrypts the PGP encrypted data files using a public key, for example, and convert the data into a common data format. As briefly discussed above, each trade data file may be coded differently with different codes used to describe the same data point (e.g., price). If the data from each of the data sources are not converted into the same format, inaccurate and thus, unreliable analysis will result.

In accordance with an exemplary embodiment of the invention, the data conversion module 40 includes a table that maps the data from the external data source into a common data format. The data mapping table includes a data element that is specific to the data source and maps that data element into the common data format. The data conversion module 40 may include one table that maps each data element from each of the data sources. Alternatively, the data conversion module 40 may include a separate table for each data source with the data map arranged specifically for the associated data source. Accordingly, as the trade data is decrypted, the data from the external data source are mapped into the common data format using the data map tables in the data conversion module 40.

The data conversion module 40 performs beginning-of-day (BOD) processing and intraday processing on the converted data. The BOD processing is performed to determine the following information: open positions, closed positions, trades, account summary, cash activity, margin requirements, collateral positions, closing prices, and currency exchange rates. The intraday processing is performed to determine the following information: intraday trade positions and intraday market prices. While the positions and trades are related to futures, options, forwards, and equities in the exemplary embodiment, other types of products may be analyzed without departing from the scope of the present invention.

As shown in FIG. 1, the analytics module 50 performs various calculations based on the data stored in the data warehouse 20. For example, the analytics module 50 determines the following information: mark to market P&L, end-of-day (EOD) P&L, proprietary P&L calculations, and proprietary option price calculations. In performing these calculations, the analytics module 50 obtains dependent data from the data warehouse 20, such as daily open positions, intraday positions, intraday real-time prices (e.g., current market prices, prior day settlement prices), and intraday trade information. These analytical data are then stored in the data warehouse 20.

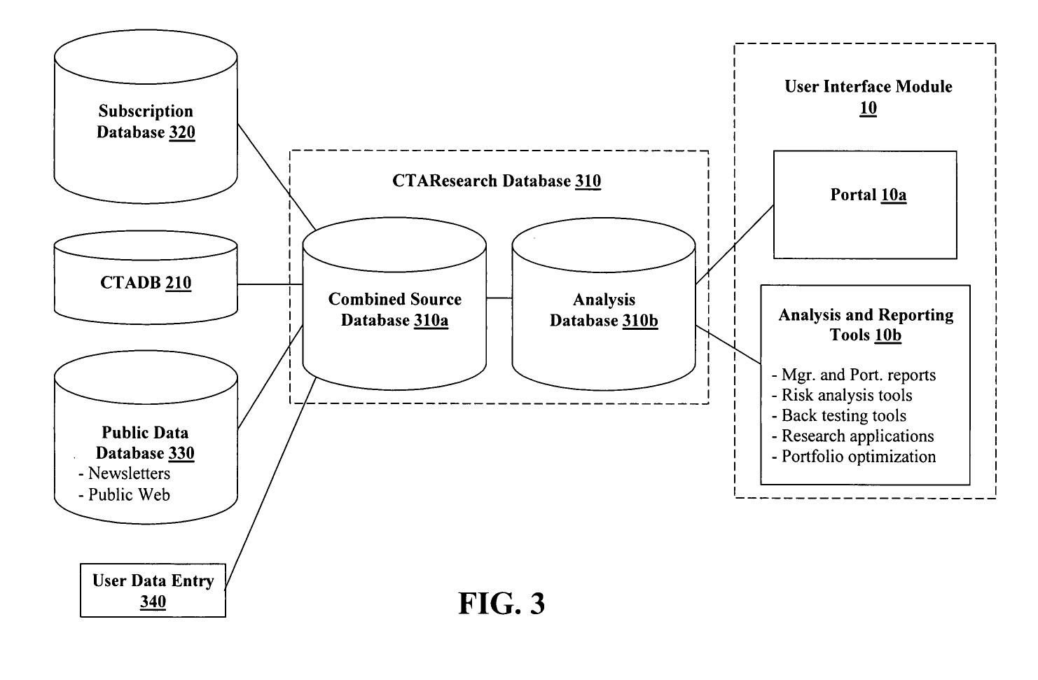

FIG. 3 shows a block diagram of the CTAResearch database structure in accordance with an exemplary embodiment of the present invention. The CTAResearch database 310 is differentiated from the CTADB database 210 in that the CTADB database 210 provides for daily information and analytics while the CTAResearch database 310 provides for historical information and analytics, such as monthly analysis. As shown, CTAResearch database 310 includes a combined source database 310a and analysis database 310b. The combined source database 310a is populated with data from the CTADB database 210, subscription database 320, and public source database 330, and other data sources 340 such as user entered data. The subscription database 320 obtains and stores source files from external data sources, such as Barclays, ITR, and Starks, for example. The source files are stored in a central repository as data arrives and date stamped according to the date of acquisition. An acquisition tool (not shown) loads data into source-specific databases. Similarly, the public source database 330 stores obtained files in a central repository and date stamped according to the date of acquisition. An acquisition tool (not shown) then loads the data into source-specific databases on a scheduled basis. Data from these external data sources are converted into a common data format in the manner described above.

User interface module 10 includes portal interface 10a and analytics tool 10b. The analytics tool 10b includes applications to perform various analyses, generate various reports, and optimize portfolios. In particular, the following are a list of functions provided by the user interface module 10 in accordance with the present invention.
INTRADAY P&L
   Intraday P&L by Managers
      P&L chart by Managers
      P&L chart by Sector for each Manager
      P&L chart by Markets for each Manager and Sector
      P&L by Fund data grid
      P&L by Manager data grid
   Intraday P&L by Funds
      P&L chart by Markets for the Fund
      P&L chart by Sector for the Fund
      P&L chart by Markets for Sector
      P&L chart by Managers for each Market
      P&L by Fund data grid
      P&L by Market and Manager data grid
      P&L by Intraday Trades and Manager data grid
      20 Most Significant P&L by Position matrix
PERFORMANCE/POSITIONS
   Daily/Historical Performance
      Daily/historical performance by Managers
         Daily Rate of Return and Value Added Monthly Index (“VAMI”)
         Month-to-date (MTD) VAMI
         Quarter-to-date (QTD) VAMI
         Year-to-date (YTD) VAMI
         Interception-to-date (ITD) VAMI
      Daily/historical Volatility
         Drawdown
         % from Knockout (“KO”)
         30-day Annual Volatility
         MTD, YTD, ITD Annual Volatility
      Daily/historical Positions
         By Sectors, Markets, and detailed transactions
            Open positions
            Positions and Sales (“PNS”)
            Trades
            P&L
   Performance/Position by Fund
PROFILES
   Manager (CTA) Profiles and Information
      Disclosure documents
      Performance statistics
      Peer group analysis
      Newsletters
      Investment Agreements (Trading Advisory Agreement)
      Links to manager websites
FUND PERFORMANCE DOCUMENTS
SYSTEM ADMINISTRATION
   Manager Management
      Add, delete, modify Mangers' account information
   User Management
      Add, delete, modify User login account
      Set security role for user
   Tab-Control Management
      Add, delete, modify displayed tab and link for user control module
      Set security access for tab
   CTA Document Management
      Add, delete, modify location of documents for each manager.

The analytics tool 10b provides the following analysis: single manager statistics, benchmark statistics, portfolio metrics, peer group rankings, and pairwise correlations. The analytics tool 10b also provides the following reports: portfolio ranking, universe ranking, investment candidates, portfolio watch lists, manger peer group analysis, and advanced search.

### EXAMPLE

The following is an example of the system and method of the present invention. It is to be understood that the following example is for illustrative purposes only.

The system and method of the present invention imports daily statements, intraday P&L data, intraday trade data from various sources, such as Goldman Sacks, Lehman Brothers, and Fimat. These data files are imported and converted into a common data format (“CDF”) by the data conversion module 40. The data is processed to create daily open positions, PNS, trades, and P&L files in CDF. In particular, the data conversion module 40 formats daily rates of returns, trades, and position data for export to the CTADB database 210. For example, the data conversion module 40 creates temporary tables containing the last 45 days worth of positional data from tables in the CTADB_Archive database, for example. The data conversion module 40 then updates the corresponding entries in the CTADB database 210. As an example, the following input/output table illustrates the updating process:

| Input (data conversion module 40) | Output (CTADB database 210) |
|---|---|
| Accounts | dailyreturns |
| Contracts | openpositions |
| Sectors | closedpositions |
| GS_archivebalances | trades |
| GS_archiveConfirm | fundrors |
| GS_archiveOpenPositions | closingprices |
| GS_archivePs | markets |
| GS_archiveTotalDetailPL | sectors |
| GS_rors | pldetail |
| Slk_archiveBalances | tblRors |
| Slk_archiveConfirm | monthlyReturns |
| Slk_archiveOpenPositions | |
| Slk_archivePS | |
| Slk_archiveTotalDetailPL | |
| tablECIRors | |

The analytics module 50 formats the intraday P&L and price data and exports to the CTADB database 210. For example, the P&L and price data files are created every 90 seconds from a spreadsheet containing P&L data obtained by the data conversion module 40. The analytics module 50 checks for a new P&L data file every 60 seconds. If a new P&L data file is detected, price and P&L data are calculated and updated to the CTADB database 210. As an example, the following input/output table illustrates the updating process:

| Input (analytics module 50) | Output (CTADB database 210) |
|---|---|
| Accounts (linked from module 40) | intradayquotes |
| Contracts (linked from module 40) | intradaypl |
| IntradayPrices | intradaytrades |
| tblPriceFeed | timestamp (increments) |
| tblWebFeed | |

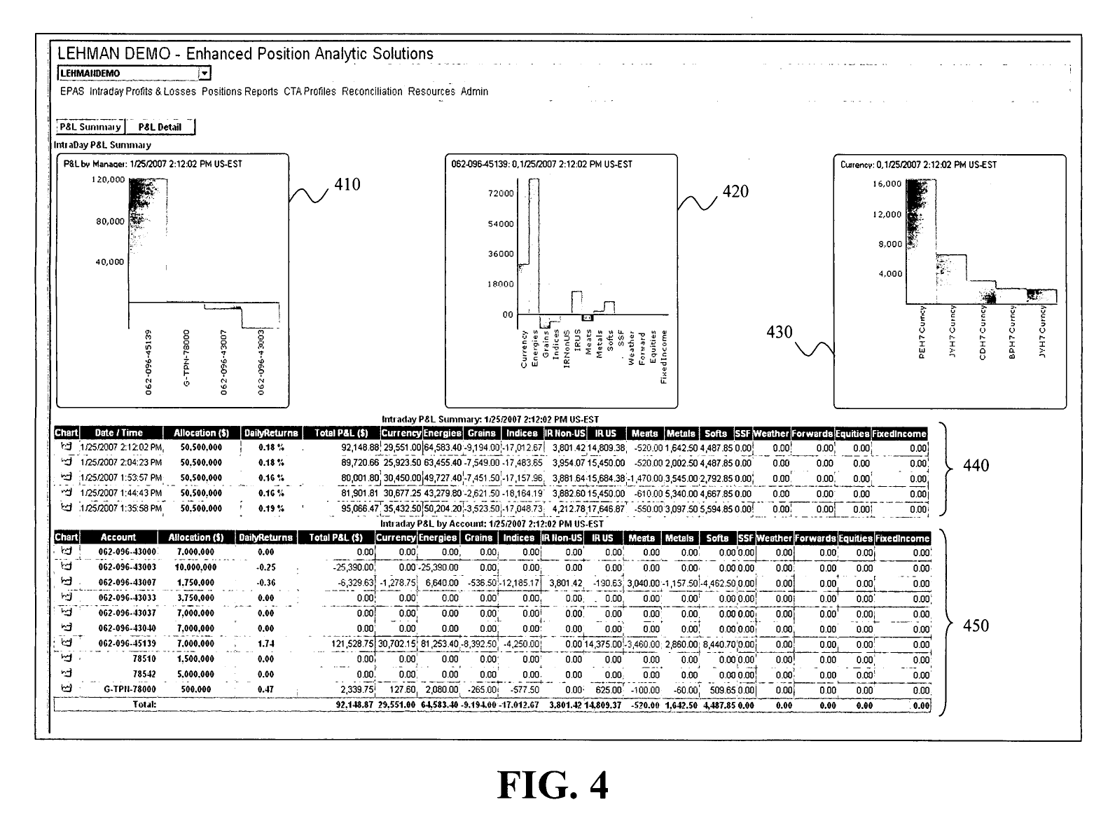

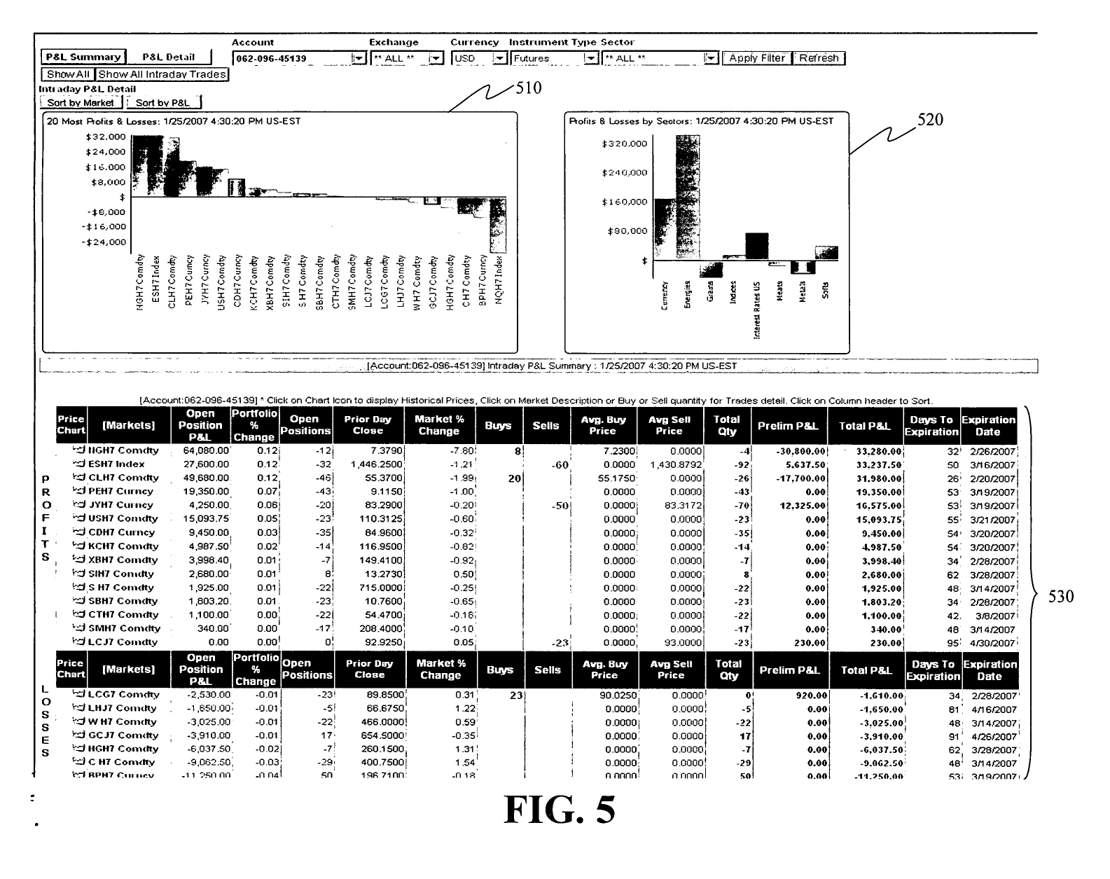

Once the CTADB database 210 has been updated, the analyses and reports as discussed above may be accessed through the user interface module 10. FIG. 4 shows an exemplary screenshot of an intraday P&L analysis page. As shown in FIG. 4, the user interface module 10 can be configured to display the P&L by manager (410), by sector (420), and by specific sector (430). Furthermore, intraday P&L summary (440) and details of each sector by manager (450) may also be shown. Various combinations of displays may be configured without departing from the scope of the present invention.

As shown in FIG. 4, each of these graphics are presented in drill-down format. That is, the user can click on any graphical item, and a more detailed display of the underlying data will be shown. In this example, if a user selects (e.g., click) the bar graph for manager's account “062-096-45139” in the P&L by Manger graphic 410, for example, the system of the present invention will drill down into the account “062-096-45139” and display the activities for this manager's account by sectors (420), for example. If the user again selects “Currency” in the P&L by Sector graphic 420, for example, the system of the present invention will drill down and display the activities of the specific currencies (430) being managed by the manager of the selected account. Each of the graphics displayed on the system of the present invention may be configured to show any combination of these analyses. For example, FIG. 5 shows a P&L analysis page that shows the 20 most significant profits and losses by markets (510), P&L by sector (520), and a detailed list of profits and losses by market (530).

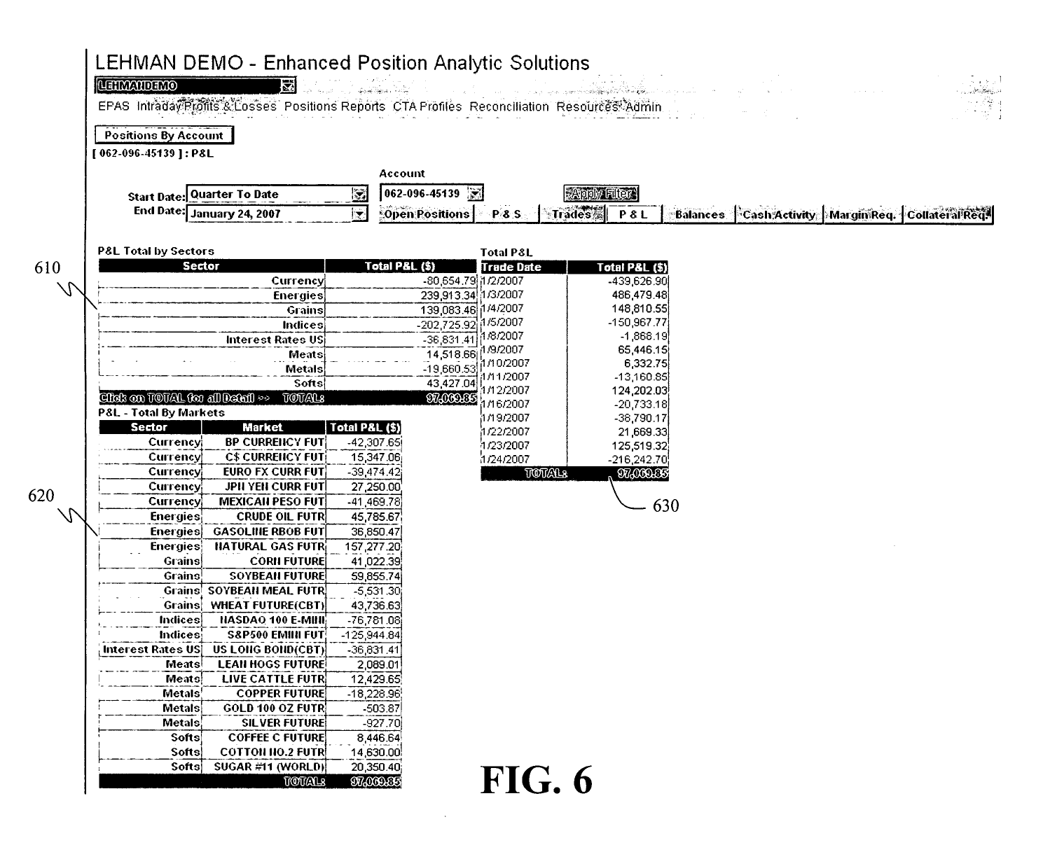

Alternatively, the P&L analysis page may be displayed by manager. As shown in FIG. 6, the P&L analysis page is displayed by manager represented by ID number “062-096-54139.” In this example, P&L analysis for this specific manager is further organized by sector (610), by market (620), and the total P&Ls according to trade dates (630), thereby providing a quick summary of a trading manager's performance at a glance.

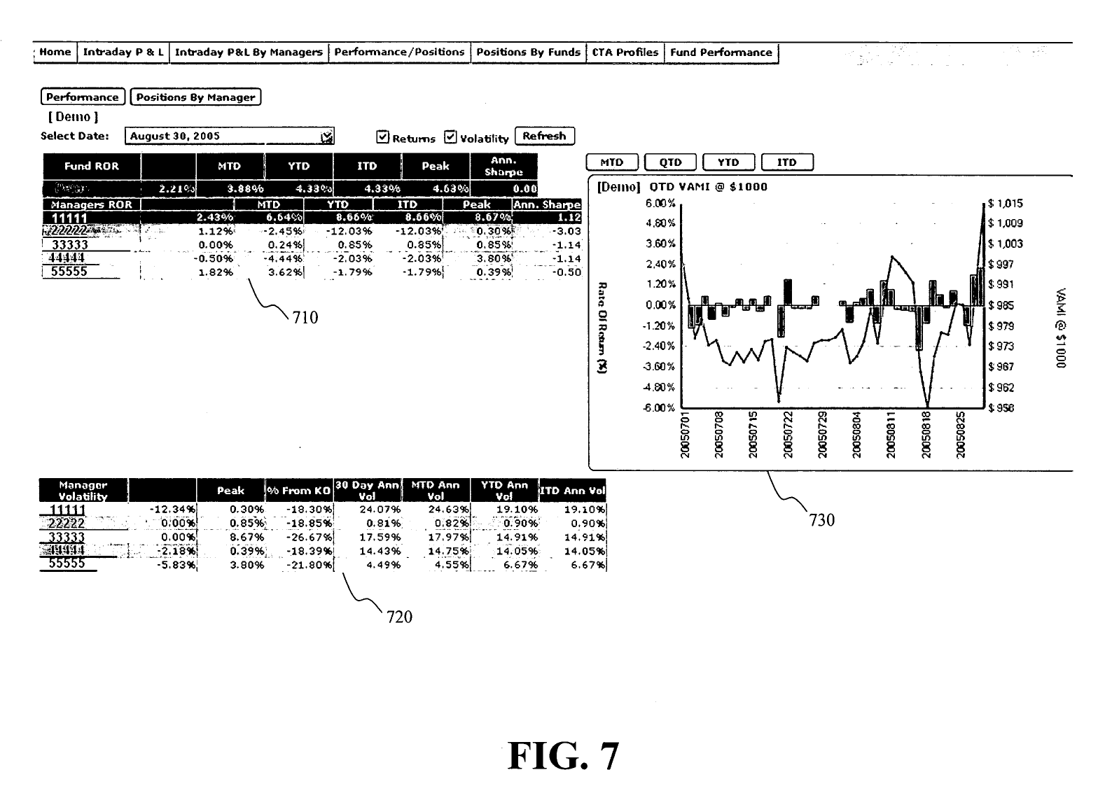

As a further alternative, the performance information may also be displayed by funds. FIG. 7 shows an exemplary screenshot of performance information by fund. In this example, the fund performance information is further categorized by managers to show the managers' rate of return (“ROR”) (710), managers' volatility (720), and the YTD VAMI (730). As explained above, any combination of the analysis to be displayed on the screen can be displayed without departing from the scope of the present invention.

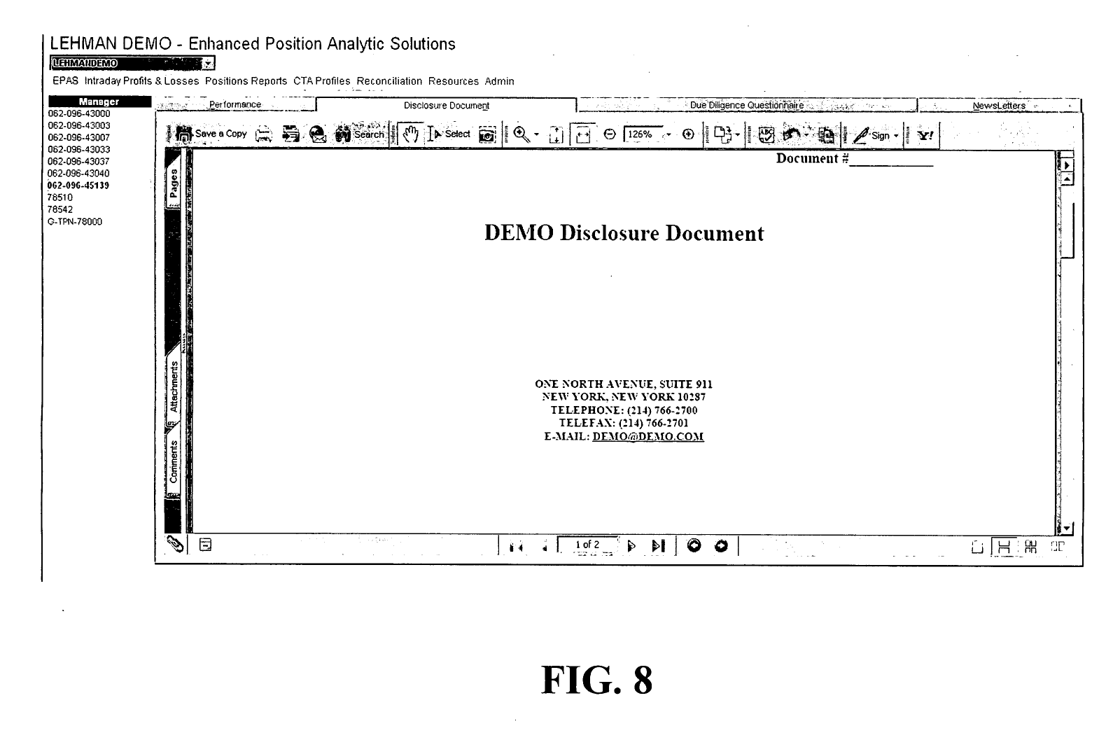

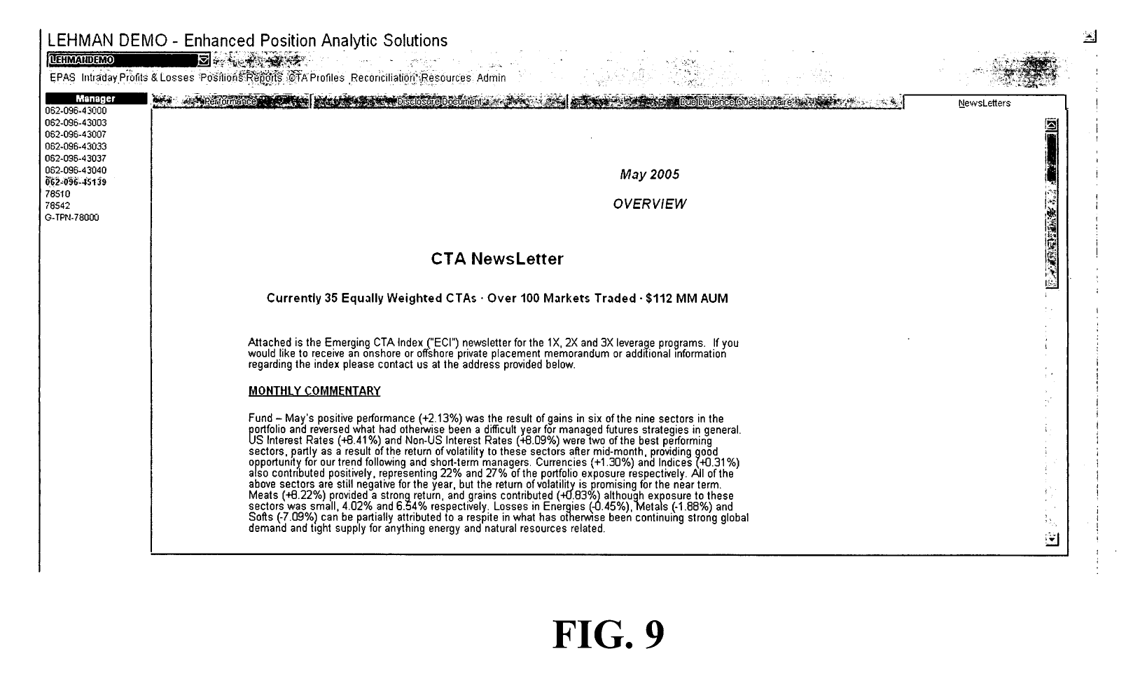

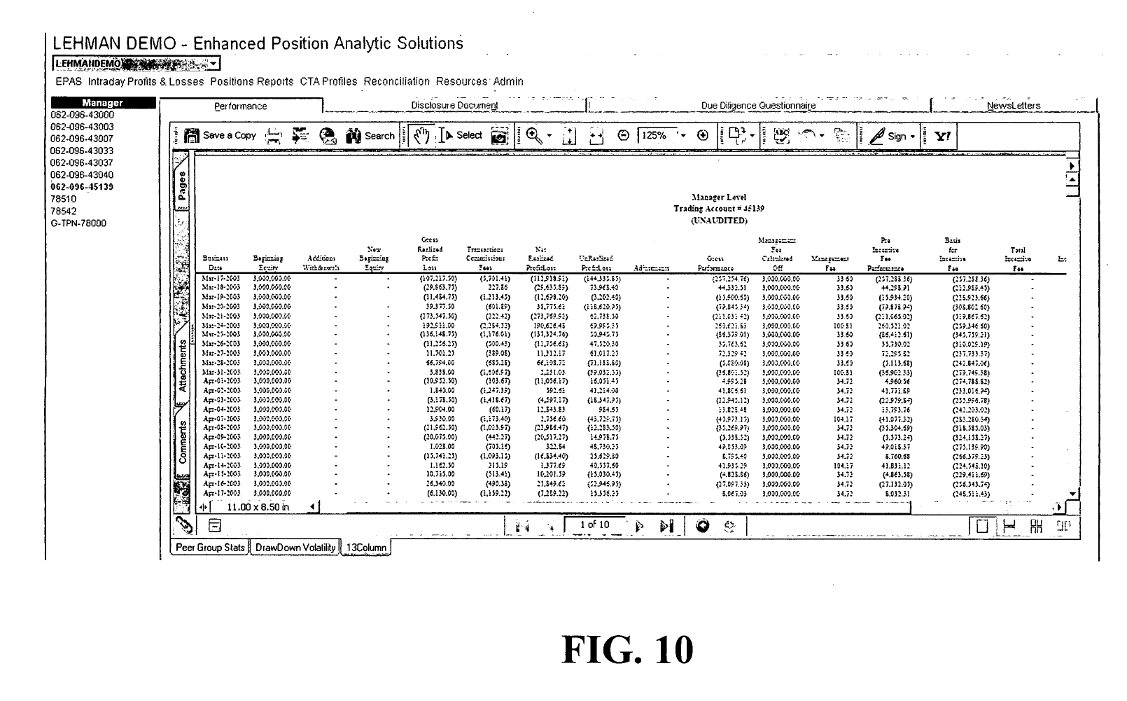

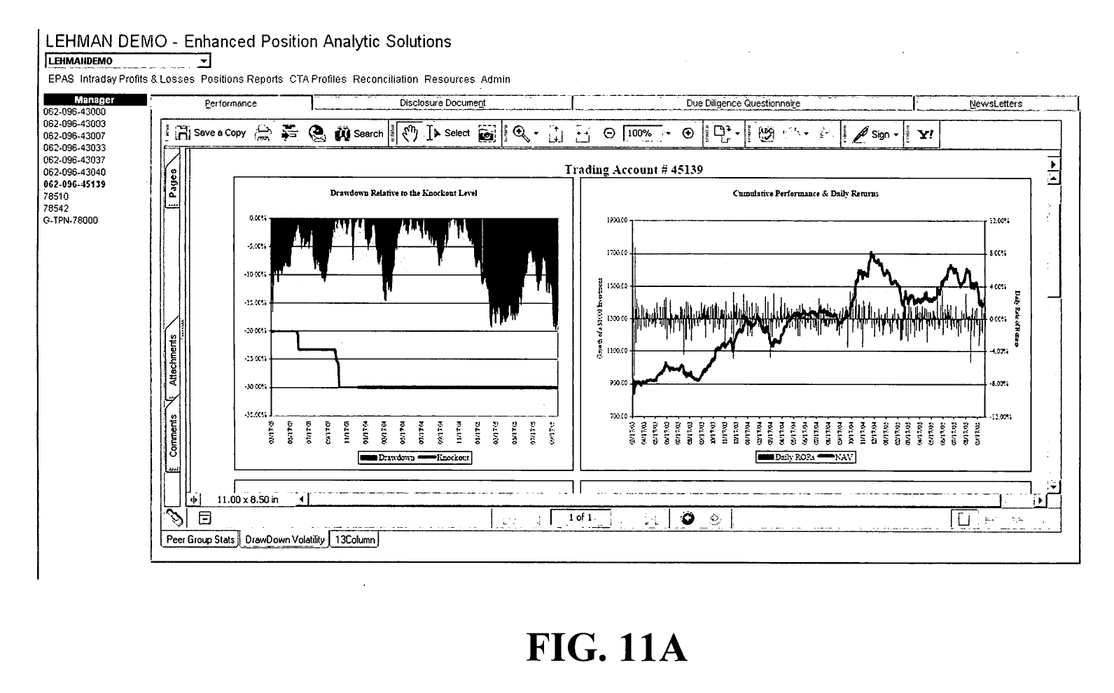

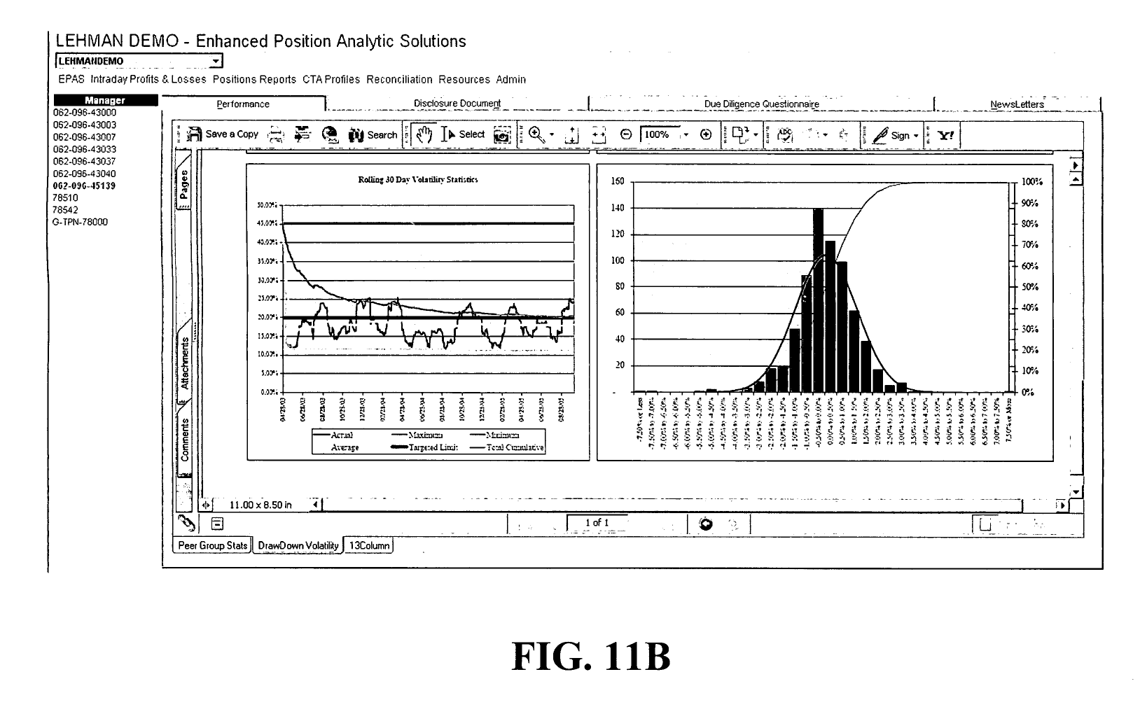

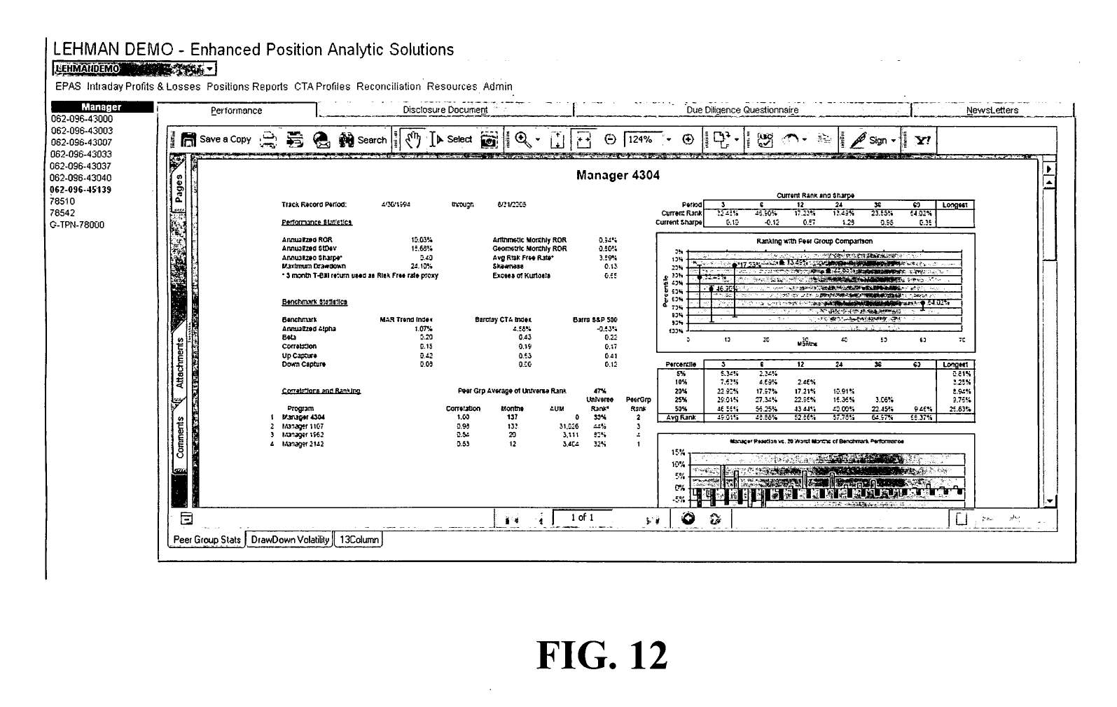

In addition to the various analytics available through the user interface module 10, the present invention also provides the user with information about each manager. For example, FIG. 8 shows an exemplary screenshot in accordance with the present invention of disclosure documents of a particular manager. FIG. 9 shows an exemplary screenshot in accordance with the present invention of a newsletter of a particular manager. FIGS. 10-12 show exemplary screenshots in accordance with the present invention of the performance report of a particular manager. Specifically, FIG. 10 shows an exemplary screenshot of a particular manager's performance in a “13 Column” format. FIGS. 11A and 11B are exemplary screenshots of the drawdown analysis of a particular manager. FIG. 12 is an exemplary screenshot of the peer group analysis of a particular manager.

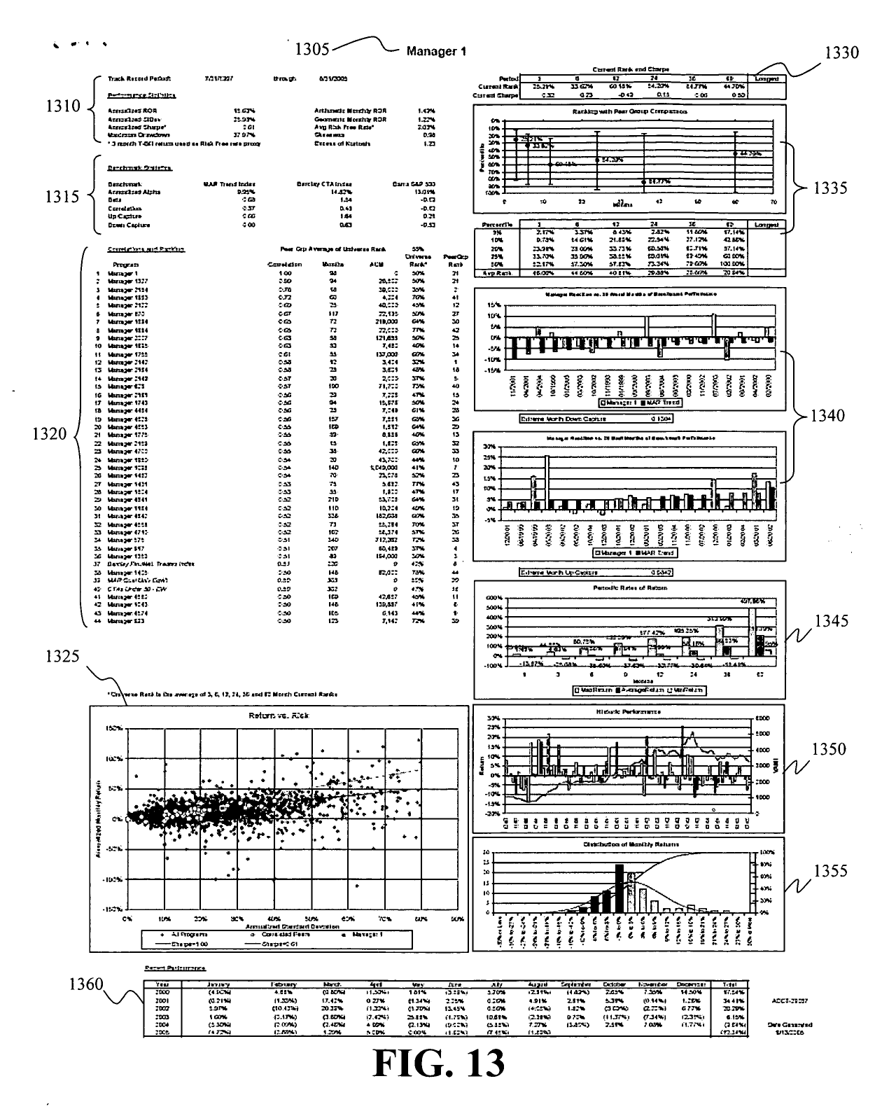

FIG. 13 shows various exemplary reports available on a particular manager. In particular, various exemplary reports may include, by manager (1305), the following reports:

Performance Statistics (1310)
Benchmark Statistics (1315)
Correlations and Rankings (1320)
Risk to Rewards (1325)
Current Rank & Sharpe (1330)
Peer Group Ranking (1335)
Manager v. Benchmark (1340)
Periodic Rate of Return (1345)
Performance History (1350)
Monthly Return Distributions (1355)
Recent Performance (1360)

Various exemplary embodiments of the present invention have been described above. It will be apparent to those skilled in the art that various modifications and variations can be made in the system and method of the present invention without departing from the spirit or scope of the invention. Thus, it is intended that the present invention cover the modifications and variations of the invention provided they come within the scope of the appended claims and their equivalents.

What is claimed is:

1. A system comprising:
a user interface module;
a data warehouse in communication with said user interface module;
an analytics module in communication with said data warehouse; and
a data conversion module in communication with said data warehouse and with at least one file server, and operable to convert data received via said at least one file server, said data being in two or more different formats, and operable to convert said data into a common data format;
wherein said data warehouse is operable to store said converted data in a common data format, and
wherein said user interface module is operable to receive a request for information regarding a fund manager, and operable to display said requested information.

2. A system as in claim 1, wherein said information regarding a fund manager comprises one or more disclosure documents of said fund manager.

3. A system as in claim 1, wherein said information regarding a fund manager comprises one or more newsletters of said fund manager.

4. A system as in claim 1, wherein said information regarding a fund manager comprises one or more performance reports of said fund manager.

5. A system as in claim 4, wherein at least one of said one or more performance reports is in a 13 column format.

6. A system as in claim 4, wherein at least one of said one or more performance reports comprises a drawdown analysis of said fund manager.

7. A system as in claim 4, wherein at least one of said one or more performance reports comprises a peer group analysis of said fund manager.

8. A system as in claim 1, wherein said user interface module is operable to display a P&L analysis page.

9. A system as in claim 8, wherein said P&L analysis page comprises one or more displays of: (a) most significant P&L by market; (b) P&L by sector; and (c) detailed list of P&L by market.

10. A system as in claim 8, wherein said P&L analysis page is operable to display one or more of: (a) intraday P&L by manager; (b) P&L chart by manager; (c) P&L chart by sector for each of one or more managers; (d) P&L chart by market for each of one or more managers and sectors; and (e) P&L by manager data grid.

11. A system as in claim 1, wherein said user interface module is operable to display a fund performance information display categorized by manager.

12. A system as in claim 11, wherein said fund performance information display categorized by manager is operable to show one or more of: (a) manager's rate of return; (b) manager's volatility; and (c) YTD VAMI.

13. A method comprising:
receiving data in two or more different formats;
converting said data into a common data format;
storing said converted data in said common data format;
receiving a request for information regarding a fund manager;
retrieving said requested information from said converted data stored in said common data format; and
displaying said requested information.

14. A method as in claim 13, wherein said information regarding a fund manager comprises one or more disclosure documents of said fund manager.

15. A method as in claim 13, wherein said information regarding a fund manager comprises one or more newsletters of said fund manager.

16. A method as in claim 13, wherein said information regarding a fund manager comprises one or more performance reports of said fund manager.

17. A method as in claim 16, wherein at least one of said one or more performance reports is in a 13 column format.

18. A method as in claim 16, wherein at least one of said one or more performance reports comprises a drawdown analysis of said fund manager.

19. A method as in claim 16, wherein at least one of said one or more performance reports comprises a peer group analysis of said fund manager.

20. A method as in claim 13, further comprising displaying a P&L analysis page.

21. A method as in claim 20, wherein said P&L analysis page comprises one or more displays of: (a) most significant P&L by market; (b) P&L by sector; and (c) detailed list of P&L by market.

22. A method as in claim 20, wherein said P&L analysis page is operable to display one or more of: (a) intraday P&L by manager; (b) P&L chart by manager; (c) P&L chart by sector for each of one or more managers; (d) P&L chart by market for each of one or more managers and sectors; and (e) P&L by manager data grid.

23. A method as in claim 13, further comprising displaying a fund performance information display categorized by manager.

24. A method as in claim 23, wherein said fund performance information display categorized by manager is operable to show one or more of: (a) manager's rate of return; (b) manager's volatility; and (c) YTD VAMI.

25. Software comprising:
software operable to receive data in two or more different formats;
software operable to convert said data into a common data format;
software operable to store said converted data in said common data format;
software operable to receive a request for information regarding a fund manager;
software operable to retrieve said requested information from said converted data stored in said common data format; and
software operable to display said requested information.

26. Software as in claim 25, wherein said information regarding a fund manager comprises one or more disclosure documents of said fund manager.

27. Software as in claim 25, wherein said information regarding a fund manager comprises one or more newsletters of said fund manager.

28. Software as in claim 25, wherein said information regarding a fund manager comprises one or more performance reports of said fund manager.

29. Software as in claim 28, wherein at least one of said one or more performance reports is in a 13 column format.

30. Software as in claim 28, wherein at least one of said one or more performance reports comprises a drawdown analysis of said fund manager.

31. Software as in claim 28, wherein at least one of said one or more performance reports comprises a peer group analysis of said fund manager.

32. Software as in claim 25, further comprising software operable to display a P&L analysis page.

33. Software as in claim 32, wherein said P&L analysis page comprises one or more displays of: (a) most significant P&L by market; (b) P&L by sector; and (c) detailed list of P&L by market.

34. Software as in claim 32, wherein said P&L analysis page is operable to display one or more of: (a) intraday P&L by manager; (b) P&L chart by manager; (c) P&L chart by sector for each of one or more managers; (d) P&L chart by market for each of one or more managers and sectors; and (e) P&L by manager data grid.

35. Software as in claim 25, further comprising software operable to display a fund performance information display categorized by manager.

36. Software as in claim 35, wherein said fund performance information display categorized by manager is operable to show one or more of: (a) manager's rate of return; (b) manager's volatility; and (c) YTD VAMI.
